(19) United States
(12) Patent Application Publication
(10) Pub. No.: US 2024/0395223 A1
(43) Pub. Date: Nov. 28, 2024

(54) COMMON VOLTAGE COMPENSATION DEVICE FOR DISPLAY PANEL, DISPLAY PANEL, AND DISPLAY DEVICE

(71) Applicants: Fuzhou BOE Optoelectronics Technology Co., Ltd., Fujian (CN); BOE Technology Group Co., Ltd., Beijing (CN)

(72) Inventors: Jinfeng CHEN, Beijing (CN); Nani LIU, Beijing (CN); Baoqiang WANG, Beijing (CN); Yifeng SU, Beijing (CN); Xiaoli KONG, Beijing (CN); Xinmao QIU, Beijing (CN); Xuening ZHAO, Beijing (CN); Qiaoni WANG, Beijing (CN); Weiming YU, Beijing (CN); Zhe HUANG, Beijing (CN); Qibiao LIN, Beijing (CN)

(21) Appl. No.: 18/032,578

(22) PCT Filed: Apr. 24, 2022
(86) PCT No.: PCT/CN2022/088715

§ 371 Date: Apr. 19, 2023

(51) Int. Cl. G09G 3/36

(52) U.S. Cl. CPC G09G 3/3696; G09G 2300/0408; G09G 2320/0209; G09G 2320/0223

(57) ABSTRACT

Common voltage compensation device for display panel is provided. The common voltage compensation device is on a first side of a display panel, and a common electrode line includes a near-end area, a far-end area, and a middle-end area; the common voltage compensation device includes a voltage feedback line, a common voltage compensation circuit, and voltage compensation lines, the voltage feedback line is connected to a feedback point at the middle-end area and is configured to detect a common voltage on the common electrode line; the common voltage compensation circuit is configured to obtain a compensation voltage according to the detected common voltage; and the voltage compensation lines are respectively connected to a first compensation point at the near-end area, a second compensation point at the middle-end area, and a third compensation point at the far-end area, and configured to transmit the compensation voltage to the common electrode line.

### TECHNICAL FIELD

The present disclosure belongs to the field of display technology, and particularly relates to a common voltage compensation device for a display panel, a display panel, and a display device.

### BACKGROUND

At present, Liquid Crystal Displays (LCDs) are applied more and more widely, and the LCDs achieve image display by driving liquid crystal molecules to rotate using a voltage difference between a common electrode and a pixel electrode. In an LCD, due to coupling capacitors existing between the common electrode and wires in the LCD, such as a coupling capacitor existing between the common electrode and a data line or a coupling capacitor existing between the common electrode and a gate line, a voltage across two ends of the coupling capacitor is suddenly changed when a signal on the gate line or the data line is suddenly changed, that is, when the signal drops to a low level from a high level or increases from a low level to a high level, with the result that a common voltage (VCOM) of the common electrode fluctuates and is hard to be kept stable, and a voltage difference between the common electrode and the pixel electrode becomes abnormal, which causes the problems of image sticking, crosstalk and the like of the LCD, and affects a display effect. Therefore, the common voltage needs to be compensated.

In the related art, a source drive printed circuit board (X-PCB) is disposed on a side of a display panel. When compensating the common voltage on the common electrode, a voltage feedback line is generally disposed at a position (which may be called a far end) of the common electrode away from the X-PCB for detecting the common voltage on the common electrode, and the compensation is performed according to the detected common voltage. However, a compensation effect of such compensation is poor.

### SUMMARY

In order to solve at least one of the problems in the related art, the present disclosure provides a common voltage compensation device for a display panel, a display panel, and a display device.

In a first aspect, embodiments of the present disclosure provide a common voltage compensation device for a display panel, the display panel includes a first side and a second side opposite to each other in a column direction, and the common voltage compensation device is disposed on the first side of the display panel,
wherein the display panel further includes a common electrode line disposed around a display region of the display panel, and the common electrode line includes a near-end area close to the first side, a far-end area close to the second side, and a middle-end area between the near-end area and the far-end area;
the common voltage compensation device includes a voltage feedback line, a common voltage compensation circuit, and voltage compensation lines,
the voltage feedback line has one end connected to a feedback point at the middle-end area of the common electrode line, and the other end connected to the common voltage compensation circuit, and is configured to detect a common voltage on the common electrode line;
the common voltage compensation circuit is configured to obtain, according to the common voltage detected by the voltage feedback line, a compensation voltage corresponding to the common voltage; and
one ends of the voltage compensation lines have one ends connected to the common voltage compensation circuit, and the other ends respectively connected to a first compensation point at the near-end area of the common electrode line, a second compensation point at the middle-end area of the common electrode line, and at least one third compensation point at the far-end area of the common electrode line, and are configured to transmit the compensation voltage to the common electrode line to compensate the common voltage.

In some embodiments, the display panel further includes a third side and a fourth side opposite to each other in a row direction, and the feedback point is located at a position of the middle-end area close to the third side; and the second compensation point is located at a position of the middle-end area close to the fourth side.

In some embodiments, the common voltage compensation circuit configured to obtain, according to the common voltage detected by the voltage feedback line, a compensation voltage corresponding to the common voltage is configured to:
determine a coupling voltage according to the common voltage detected by the voltage feedback line and a preset common voltage threshold; and
perform inverse feedback processing on the coupling voltage according to compensation multiples of the first compensation point, the second compensation point and the third compensation point to respectively obtain a compensation voltage for the first compensation point, a compensation voltage for the second compensation point, and a compensation voltage for the third compensation point.

In some embodiments, the compensation multiples of the first compensation point, the second compensation point, and the third compensation point are the same or different.

In some embodiments, the voltage compensation lines include at least one first compensation line connected to the first compensation point, a second compensation line connected to the second compensation point, and a third compensation line connected to the at least one third compensation point.

In some embodiments, the first compensation point is at a middle position of the near-end area; and the number of the at least one third compensation points is two, and the two third compensation points are located on two sides of the far-end area, and are respectively connected to corresponding third compensation lines.

In a second aspect, the embodiments of the present disclosure provide a display panel, including the common voltage compensation device for the display panel described above.

In some embodiments, the display panel includes a display panel without a Pattern Detect Function (PDF).

In some embodiments, the display panel includes a vertical-screen display panel based on Chip on Glass (COG) technology, and a size of the display panel is greater than or equal to a preset size threshold.

In a third aspect, the embodiments of the present disclosure provide a display device, including the display panel described above.

### BRIEF DESCRIPTION OF DRAWINGS

FIG. 1a and FIG. 1b are schematic diagrams illustrating a display image and a principle of a greenish image.

FIG. 2 is a schematic diagram illustrating common voltage feedback and compensation of a display panel in the related art.

FIG. 3 is a schematic diagram illustrating common voltage feedback and compensation of a display panel according to the embodiments of the present disclosure.

FIG. 4 is a schematic diagram of a test result of common voltage compensation according to the embodiments of the present disclosure.

### DETAIL DESCRIPTION OF EMBODIMENTS

In order to enable those of ordinary skill in the art to better understand the technical solutions of the present disclosure, the present disclosure is further described in detail below with reference to the drawings and specific embodiments.

Unless otherwise defined, technical terms or scientific terms used herein should have general meanings that are understood by those of ordinary skill in the technical field to which the present disclosure belongs. The words “first”, “second” and the like used herein do not denote any order, quantity or importance, but are just used to distinguish between different elements. Similarly, the words “one”, “a”, “the” and the like do not denote a limitation to quantity, and indicate the existence of “at least one” instead. The words “include”, “comprise” and the like indicate that an element or object before the words covers the elements or objects listed after the words or the equivalents thereof, rather than excluding other elements or objects. The words “connect”, “couple” and the like are not restricted to physical or mechanical connection, but may also indicate electrical connection, whether direct or indirect. The words “on”. “under”, “left”, “right” and the like are only used to indicate relative positional relationships. When an absolute position of an object described is changed, the relative positional relationships may also be changed accordingly.

In the field of display technology, the Chip on Glass (COG) technology refers to a technology of directly bonding a driver IC chip onto a glass substrate. The COG technology reduces welding processes of a display panel, greatly reduces a volume ratio of the display panel, facilitates miniaturize, simplification and high integration, is beneficial to reduction in comprehensive cost, and is commonly applied to small-sized portable display products. Due to high integration of the COG IC chip (3-in-1 function of timing controller (TCON)/source drive (Source)/level shift (Level Shift)), the COG IC chip is superior in circuit cost, and can save electronic devices (for example, the number of components in a display product is generally 280 pcs, while by adopting the solution of the COG IC chip, the number of the components can be reduced to 120 pcs).

In recent years, more and more manufacturers try to apply the COG technology to small and medium-sized display products, and even to medium and large-sized display products. However, since the COG technology has the characteristic of high integration and is conventionally applied to the small and medium-sized display products in the past, some functions (e.g., a Pattern Detect Function (PDF)) needed by the medium and large-sized display products cannot be integrated into the COG technology. Thus, after the COG technology is applied to the medium and large-sized display products, the phenomena that VCOM compensation is not in place and a shift of VCOM due to signal coupling cannot be recovered on time occur, which causes problems that special display images are greenish and the like.

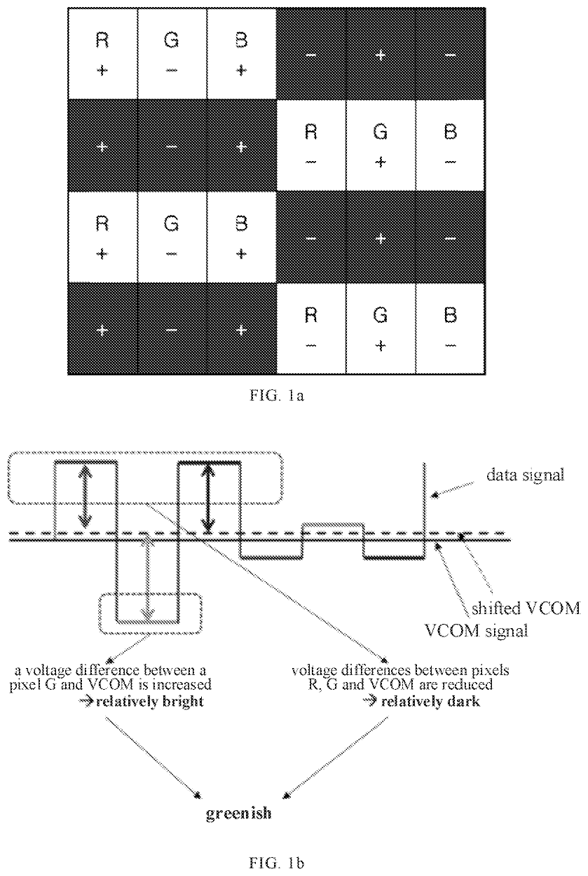

FIG. 1a and FIG. 1b are schematic diagrams illustrating a display image and a principle of a greenish image. FIG. 1a shows pixels of a 1dot display image, and for 1dot display image, adjacent pixels are white and black respectively. FIG. 1b shows a data signal and a VCOM signal of the pixels of the 1dot display image. In a case where column architecture is adopted and column inversion is used for display, among the pixels in the first row of the 1dot display image, the pixels whose data signals have a positive polarity (i.e., a red pixel R and a blue pixel B) are more, the pixels whose data signals have a negative polarity (i.e., a green pixel R) are less, and a coupling capacitor causes the VCOM signal to be upwardly shifted to a position represented by the dotted line in FIG. 1b. If the VCOM signal cannot be recovered on time, a difference between the voltage of each of the pixels R and B whose data signals have the positive polarity and VCOM will be reduced and the pixels R and B will be relatively dark; and s difference between the voltage of the pixel G whose data signal has the negative polarity and VCOM will be increased and the pixel G will be relatively bright. Similarly, it can be concluded that the pixels G are relatively bright and the pixels R and B are relatively dark among the pixels in the other rows of the 1dot image, resulting in a phenomenon that the image is greenish.

For a conventional display product such as a Chip On Film (COF) display product, a timing controller TCON of the display product is independent and has a strong function, and the pattern detect function PDF can be used, so as to change a polarity of data output for such image, ensure balance between positive polarity and negative polarity of data, thereby enabling VCOM to be less affected by data coupling or quickly recovered after being affected.

In addition to the PDF described above, in order that VCOM can be quickly recovered after being shifted due to signal coupling, only VCOM feedback and compensation can be considered. A method of symmetrical bilateral two-point sampling feed back and symmetrical near-end \textcircled{1}/middle-end \textcircled{2}/far-end \textcircled{3} bilateral compensation input is generally adopted for the conventional medium and large-sized display products.

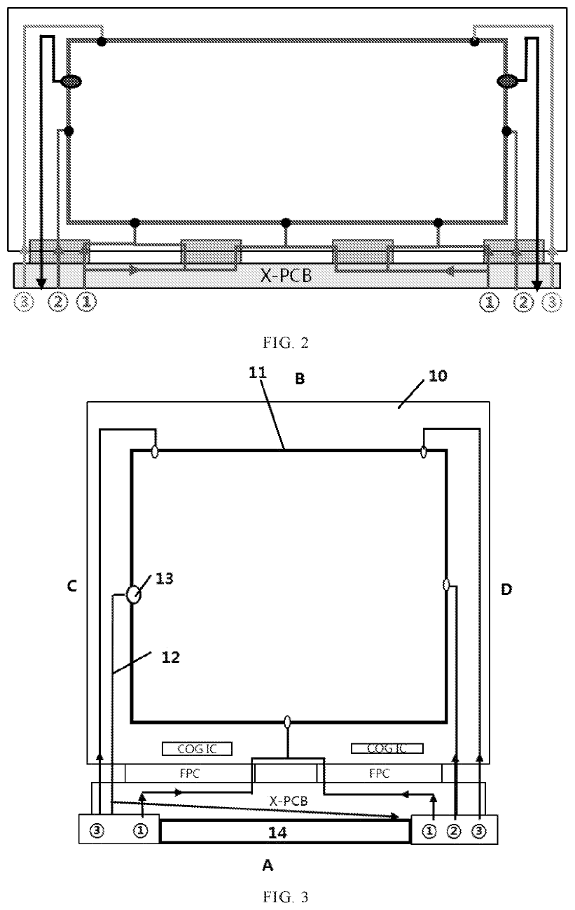

FIG. 2 is a schematic diagram illustrating common voltage feedback and compensation of a display panel in the related art. As shown in FIG. 2, an X-PCB is disposed on a side of a display panel, and a common electrode line is disposed around a display region of the display panel. When compensating a common voltage (VCOM) on the common electrode line, voltage feedback lines (the downward arrows in FIG. 2) are provided at positions (the larger dots in FIG. 2) of the common electrode line away from the X-PCB or at middle positions of the common electrode line to detect the common voltage on the common electrode. A compensation voltage is obtained according to a detected common voltage, and the compensation is respectively performed through a plurality of compensation lines (\textcircled{1}, \textcircled{2}, \textcircled{3} in FIG. 2) at a plurality of points (corresponding to the compensation lines \textcircled{1} in FIG. 2) on the common electrode line at positions (called near ends) close to the X-PCB, two symmetrical points (corresponding to the compensation lines \textcircled{2} in FIG. 2) on the common electrode line which are located at middle positions (called middle ends) and on two sides, and two symmetrical points (corresponding to the compensation lines \textcircled{3} in FIG. 2) on the common electrode line which are located at positions (called far ends) far away from the X-PCB and on two sides.

For conventional small and medium-sized display products, generally, the method of symmetrical bilateral two-point sampling feed back illustrated by FIG. 2 is also adopted, or in consideration of cost and practical effects, a method of symmetrical near-end \textcircled{1}/far-end \textcircled{3} bilateral compensation input is adopted, that is, the compensation lines \textcircled{2} in FIG. 2 are removed, and the compensation lines \textcircled{1}, \textcircled{3} in FIG. 2 are kept.

For small and medium-sized COG display products or small-sized (e.g. 10.1 inches) COG display products, the above VCOM compensation method for the conventional display products may be adopted, or, a method of direct input without feedback may be adopted. Due to the small sizes of the products, influences of coupling on in-panel wires are small, so that a direct driving method can also ensure stable VCOM in display screens.

However, for medium and large-sized (e.g., 21.45 inches) COG display products, especially for medium and large-sized vertical-screen COG display products, the VCOM common electrode line in a vertical direction is longer in a display panel, therefore, even if the above VCOM feedback compensation method for the conventional medium and large-sized display products is adopted, the problem that the 1dot image is greenish due to coupling of the VCOM by data cannot be solved, and the image is greenish to an unusually severe extent.

The embodiments of the present disclosure provide a common voltage compensation device for a display panel, which adopts an asymmetric heterotype VCOM feedback and compensation input solution as follows: a feedback point for a common voltage VCOM is provided on one side at a middle end, and a signal from the feedback point is subjected to inverse feedback and compensatorily input into a middle position at a near end, the other side at a middle end, and two sides at a far end, so as to achieve effective and suitable compensation by external compensation input and quick recovery from the shift, thereby effectively solving a problem of a shift of a common voltage caused by coupling of the common voltage by data, and improving a display effect of a display panel.

FIG. 3 is a schematic diagram illustrating common voltage feedback and compensation of a display panel according to the embodiments of the present disclosure. As shown in FIG. 3, a display panel 10 includes a first side A and a second side B opposite to each other in a column direction, a common voltage compensation device is disposed on the first side A of the display panel, an X-PCB is also located on the first side A of the display panel and connected to the display panel through a Flexible Printed Circuit (FPC), and a COG IC chip is bonded onto a glass substrate of the display panel.

In some embodiments, the display panel 10 further includes a common electrode line 11 disposed around a display region of the display panel, and the common electrode line include a near-end area close to the first side A, a far-end area close to the second side B and far away from the first side A, and a middle-end area between the near-end area and the far-end area.

In some embodiments, as shown in FIG. 3, the common voltage compensation device provided by the embodiments of the present disclosure includes a voltage feedback line 12, a common voltage compensation circuit 14, and voltage compensation lines (corresponding to \textcircled{1}, \textcircled{2}, \textcircled{3} in FIG. 3).

The voltage feedback line 12 has one end connected to a feedback point 13 at the middle-end area of the common electrode line, and the other end connected to the common voltage compensation circuit 14, and is configured to detect a common voltage on the common electrode line 11.

The common voltage compensation circuit 14 is configured to obtain, according to the common voltage VCOM detected by the voltage feedback line 12, a compensation voltage corresponding to the common voltage.

The voltage compensation lines have one ends connected to the common voltage compensation circuit, and the other ends respectively connected to a first compensation point at the near-end area of the common electrode line, a second compensation point at the middle-end area of the common electrode line, and at least one third compensation point at the far-end area of the common electrode line, and are configured to transmit the compensation voltage to the common electrode line to compensate the common voltage.

For example, in addition to the common electrode line 11 arranged around the display region of the display panel, the display panel may further include a plurality of common electrode lines (not shown) in the display region, such as a plurality of common electrode lines arranged side by side in the column direction of the display panel, and the plurality of common electrode lines are configured to supply a common voltage to the display region, so that liquid crystal molecules in each pixel can be driven to rotate by a voltage difference between the common voltage and a signal voltage of the pixel, thereby implementing image display.

In some embodiments, the display panel further includes a third side C and a fourth side D opposite to each other in a row direction, and the feedback point may be located close to the third side C in the middle-end area, i.e., the feedback point 13 in FIG. 3; and the second compensation point may be located close to the fourth side D in the middle-end area, i.e., an intersection point of the compensation line \textcircled{2} and the common electrode line 11 in FIG. 3. It should be understood that the feedback point may also be arranged close to the fourth side D in the middle-end area, and the second compensation point may also be arranged close to the third side C in the middle-end area, which is not limited by the present disclosure.

In some embodiments, the feedback point and the second compensation point may be arranged at middle positions of the middle-end area, or may be arranged at positions of the middle-end area close to the first side or the second side; and the positions of the feedback point and the second compensation point may also be asymmetrically arranged, and the specific positions of the feedback point and the second compensation point are not limited by the present disclosure.

According to the embodiments of the present disclosure, arranging the feedback point at the middle-end area can shorten a signal delay of the detected common voltage, and improve accuracy of the detected common voltage; and arranging the second compensation point at the position of the middle-end area opposite to the feedback point can improve a compensation speed and a compensation effect for the middle-end area of the common electrode line.

Due to limited wiring regions of the COG display products, it is not allowed to arrange too many feedback points and compensation points. According to the embodiments of the present disclosure, compensation for the common voltage can be achieved and the display effect of the display panel can be improved under the condition that the number of the feedback points and the compensation points is relatively small.

In some embodiments, one end of the voltage feedback line 12 is connected to the feedback point 13 at the middle-end area of the common electrode line, and the other end of the voltage feedback line 12 is connected to the common voltage compensation circuit 14 to input the detected common voltage into the common voltage compensation circuit 14.

In some embodiments, the common voltage compensation circuit 14 is configured to obtain, according to the common voltage detected by the voltage feedback line, the compensation voltage corresponding to the common voltage. The common voltage compensation circuit 14 may be disposed on the X-PCB or outside the X-PCB, which is not limited by the present disclosure.

In some embodiments, the common voltage compensation circuit 14 may include a plurality of operational amplifiers (OP), and determines the compensation voltage by inverse feedback. The common voltage compensation circuit obtains the compensation voltage corresponding to the common voltage according to the common voltage detected by the voltage feedback line in the following way:

determining a coupling voltage according to the common voltage detected by the voltage feedback line and a preset common voltage threshold; and performing inverse feedback processing on the coupling voltage according to compensation multiples of the first compensation point, the second compensation point and the third compensation point to respectively obtain a compensation voltage for the first compensation point, a compensation voltage for the second compensation point, and a compensation voltage for the third compensation point.

For example, the common voltage compensation circuit 14 may determine a voltage difference between the common voltage detected by the voltage feedback line and the preset common voltage threshold, and takes the voltage difference as the coupling voltage. If the detected common voltage is greater than the common voltage threshold, a value of the coupling voltage is positive; on the contrary, if the detected common voltage is less than the common voltage threshold, the value of the coupling voltage is negative. A specific value of the common voltage threshold is not limited by the present disclosure.

In some embodiments, the compensation multiples of the first compensation point, the second compensation point, and the third compensation point may be set in advance. The compensation multiples of the first compensation point, the second compensation point, and the third compensation point may be the same or different. The compensation multiples of the first compensation point, the second compensation point, and the third compensation point may be determined through actual tests or through circuit simulation, which is not limited by the present disclosure.

In some embodiments, according to the compensation multiples of the first compensation point, the second compensation point, and the third compensation point, the common voltage compensation circuit 14 may perform the inverse feedback processing on the coupling voltage to respectively obtain the compensation voltage for the first compensation point, the compensation voltage for the second compensation point, and the compensation voltage for the third compensation point. That is, if the value of the coupling voltage is positive, a value of each compensation voltage is negative; and if the value of the coupling voltage is negative, the value of each compensation voltage is positive, thereby causing a compensated common voltage to approximate to the common voltage threshold.

In this way, the compensation for the common voltage can be achieved, and a shift of the common voltage can be reduced, so that the display effect of the display panel can be improved.

In some embodiments, the voltage compensation lines have one ends connected to the common voltage compensation circuit, and the other end respectively connected to the first compensation point at the near-end area of the common electrode line, the second compensation point at the middle-end area of the common electrode line, and the at least one third compensation point at the far-end area of the common electrode line, and are configured to transmit the compensation voltages to the common electrode line to compensate the common voltage.

In some embodiments, the voltage compensation lines include at least one first compensation line connected to the first compensation point, a second compensation line connected to the second compensation point, and a third compensation line connected to the at least one third compensation point.

In some embodiments, the first compensation point is at a middle position of the near-end area. The number of the third compensation points is two, and the two third compensation points are located on two sides of the far-end area, and are respectively connected to corresponding third compensation lines.

That is, the number of the at least one first compensation line may be one or more. As shown in FIG. 3, two first compensation lines (corresponding to \textcircled{1} in FIG. 3) are provided and are both connected to the first compensation point at the middle position of the near-end area. In a case where a plurality of first compensation points are provided, a plurality of first compensation lines may be respectively connected to the corresponding first compensation points.

In some embodiments, the number of the second compensation line (corresponding to \textcircled{2} in FIG. 3) may be one, and the one second compensation line is connected to the second compensation point at the middle-end area.

In some embodiments, the number of the third compensation point(s) may be one or more, and each third compensation point is provided with a corresponding third compensation line. In a case where two third compensation points (corresponding to \textcircled{3} in FIG. 3) are provided, the two third compensation points are located on two sides of the far-end area, and are respectively connected to the corresponding third compensation lines.

In this way, fewer compensation points are provided at the near-end area and the middle-end area with shorter delays, and more compensation points are provided at the far-end area with a longer delay, so that a compensation effect can be improved under the condition that the number of the compensation points is limited.

The common voltage compensation device for the display panel provided by the embodiments of the present disclosure can ensure that the feedback point really reflects a VCOM compensation condition in the display panel, so that it can be ensured that overcompensation at near-end and far-end caused by too large coupling of the middle-end feedback point is avoided, it can also be ensured that insufficient compensation at near-end and far-end caused by a too small coupling of the middle-end feedback point is avoided, and meanwhile, the coupling voltage can be quickly recovered within one-row display time to achieve balance and better condition.

The common voltage compensation device for the display panel provided by the embodiments of the present disclosure can be applied to any display panel without the PDF, especially vertical-screen display panels based on the COG technology, and sizes of the display panels are greater than or equal to a preset size threshold, that is, the display panels are medium and large-sized display panels. For example, the preset size threshold is set to 20 inches, but a specific value of the preset size threshold is not limited by the present disclosure.

In some embodiments, the compensation effect of VCOM may be represented by coupling voltage/recovery time. The smaller the coupling voltage is, the smaller the shift of the common voltage VCOM is, and the better the compensation effect is. The less the recovery time is, the greater the voltage recovery speed of VCOM compensation is, and the better the display effect is.

The one-row display time of the display panel is about 8.5 us (in a case of 60 Hz) in actual tests.

For medium and large-sized vertical-screen COG display panels, if the conventional common voltage VCOM feedback and compensation method (as shown in FIG. 2) for the medium and large-sized display products is adopted, for example, the compensation multiple of each compensation point is set to be 1, the compensation condition in the display panel is determined through tests, and a coupling condition of the feedback point in the 1dot image obtained through actual tests is: coupling voltage/recovery time=168 mV/8.5 us. That is, the common voltage VCOM is shifted due to data coupling during the whole period of one-row display time, which causes an unusually severe greenish phenomenon. Based on this solution, after increasing the compensation multiple, it is found through tests that the coupling voltage is further increased and the recovery time cannot be reduced, with the result that actual in-plane compensation is still not in place.

For the medium and large-sized vertical-screen COG display panels, if the conventional VCOM feedback and compensation method for the small and medium-sized display products is adopted, that is, the compensation lines \textcircled{2} in FIG. 2 are removed and the compensation lines \textcircled{1}, \textcircled{3} in FIG. 2 are kept, after the compensation multiples are adjusted to optimal conditions (the near-end compensation multiple needs to be set to 15, and the far-end compensation multiple needs to be set to 24), a compensation condition in the screen determined through tests is: 320 mV/4.28 us. Compared with an initial display state, although the recovery time can be reduced (from 8.5 us to 4.28 us), the coupling voltage is increased (from 168 mV to 320 mV), and overcompensation occurs after the compensation and amplification, with the result that the whole image is reddish and the display effect is still poor.

For the medium and large-sized vertical-screen COG display panels, when the common voltage compensation device for the display panel provided by the embodiments of the present disclosure is adopted, that is, the above asymmetric heterotype common voltage VCOM feedback and compensation method is adopted, after the compensation multiples are adjusted to optimal conditions (the compensation multiple of the first compensation point at the near-end area is set to 10, the compensation multiple of the second compensation point on the right side at the middle-end area is set to 75, and the compensation multiple of the third compensation point at the far-end is set to 24), a compensation condition in the screen determined through tests is: coupling voltage/recovery time=168 mV/2.12 us.

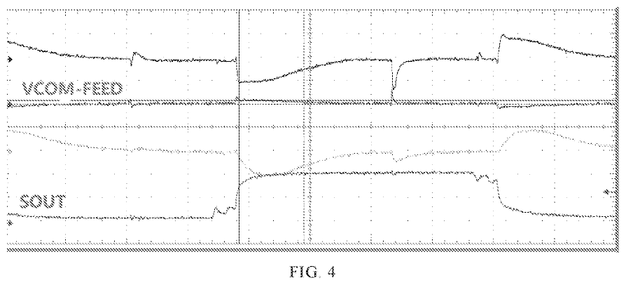

FIG. 4 is a schematic diagram of a test result of common voltage compensation according to an embodiment of the present disclosure. As shown in FIG. 4, VCOM-FEED represents a common voltage obtained through a test, and SOUT represents a voltage of a data signal obtained through the test. As can be seen, within a time period (8.5 us) when SOUT is at a high level, VCOM-FEED is shifted to certain extent at a rising edge when SOUT is switched to the high level, but is compensated and recovered after the recovery time (about 2.12 us), and the coupling voltage is relatively small; and the compensation effect is similar within a time period when SOUT is at a low level.

Compared with an initial display state, although the compensation multiples are increased, the recovery time can be significantly reduced (from 8.5 us to 2.12 us) under the condition that the coupling voltage is kept unchanged. Actual Δy of a display image obtained through the test is reduced from a default value of −0.1288 before the improvement to −0.0145 after the improvement, and is within a preset threshold range of |Δy|. As can be seen, the embodiments of the present disclosure can achieve significant improvement in the display effect of the display panel.

In some embodiments, Δy may represent a difference between display parameters (color gamut, brightness, etc.) of a full bright display image and display parameters of the 1dot display image, and is configured to represent the display effect of the display panel. The smaller |Δy| is, the better the display effect is. For example, the preset threshold of |Δy| may be set to 0.02, but is not limited by the present disclosure.

It should be understood that a value of the compensation multiple of each compensation point and values of coupling voltage and recovery time after the compensation may be changed according to different display panels, and are not limited by the present disclosure.

The common voltage compensation device for the display panel provided by the embodiments of the present disclosure adopts the asymmetric heterotype VCOM feedback and compensation input solution, that is, the feedback point (such as the point on the left side of the middle-end area) for the common voltage VCOM is provided only on one side of the middle-end area, and the signal from the feedback point is subjected to inverse feedback and compensatorily input into the middle position of the near-end area, the other side of the middle-end area, and the two sides of the far-end area. Under the condition that the limited wiring regions of the COG display products do not allow configuration of too many feedback points and compensation points, the problem that the display image is greenish caused by the shift of VCOM due to coupling of the common voltage VCOM by display data is effectively solved, so that effective and suitable compensation can be achieved by the external compensation input, and the shifted common voltage can be recovered quickly, thereby effectively improving the display effect of the display panel (especially the medium and large-sized vertical-screen COG display panels).

The embodiments of the present disclosure further provide a display panel, including the above common voltage compensation device for the display panel. A specific type of the display panel is not limited by the present disclosure.

In some embodiments, the display panel includes a display panel without a PDF. That is, the common voltage compensation device for the display panel may be extensively applied to any display panel without the PDF, such as a conventional display panel with a TCON IC chip, so as to reduce a cost for common voltage compensation of display products while improving a display effect.

In some embodiments, the display panel includes a vertical-screen display panel based on the COG technology, and a size of the display panel is greater than or equal to a preset size threshold. For example, the preset size threshold is set to 20 inches, but a specific value of the preset size threshold is not limited by the present disclosure.

The embodiments of the present disclosure further provide a display device, including the above display panel. The display device may be any product or component with a display function, such as a mobile phone, a tablet computer, a television, a display, a notebook computer, a digital photo frame, or a navigator. The inclusion of other essential components in the display device should be apparent to those of ordinary skill in the art, will not be described here, and should not be considered as a limitation to the present disclosure.

The circuits or sub-circuits described in the embodiments of the present disclosure may be implemented as software or hardware. The described circuits or sub-circuits may also be disposed in a processor, for example, such description may be given: a processor, including: a receiving circuit and a processing circuit, and the processing circuit includes a write sub-circuit and a read sub-circuit. The names of those circuits or sub-circuits do not constitute any limitation to the circuits or sub-circuits themselves in some cases, for example, the receiving circuit may also be described as “receiving a video signal”.

It should be understood that the above embodiments are merely exemplary embodiments adopted to illustrate the principle of the present disclosure, and the present disclosure is not limited thereto. Various modifications and improvements can be made by those of ordinary skill in the art without departing from the spirit and essence of the present disclosure, and those modifications and improvements are also considered to fall within the scope of the present disclosure.

1. A common voltage compensation device for a display panel, wherein the display panel comprises a first side and a second side opposite to each other in a column direction, and the common voltage compensation device is on the first side of the display panel,
the display panel further comprises a common electrode line around a display region of the display panel, and the common electrode line comprises a near-end area close to the first side, a far-end area close to the second side, and a middle-end area between the near-end area and the far-end area;
the common voltage compensation device comprises a voltage feedback line, a common voltage compensation circuit, and voltage compensation lines,
the voltage feedback line has one end connected to a feedback point at the middle-end area of the common electrode line, and the other end connected to the common voltage compensation circuit, and is configured to detect a common voltage on the common electrode line;
the common voltage compensation circuit is configured to obtain, according to the common voltage detected by the voltage feedback line, a compensation voltage corresponding to the common voltage; and
the voltage compensation lines have one ends connected to the common voltage compensation circuit, and the other ends respectively connected to a first compensation point at the near-end area of the common electrode line, a second compensation point at the middle-end area of the common electrode line, and at least one third compensation point at the far-end area of the common electrode line, and are configured to transmit the compensation voltage to the common electrode line to compensate the common voltage.

2. The device of claim 1, wherein the display panel further comprises a third side and a fourth side opposite to each other in a row direction, and the feedback point is at a position of the middle-end area close to the third side a; and the second compensation point is at a position of the middle-end area close to the fourth side.

3. The device of claim 1, wherein the common voltage compensation circuit configured to obtain the compensation voltage corresponding to the common voltage according to the common voltage detected by the voltage feedback line is configured to:
determine a coupling voltage according to the common voltage detected by the voltage feedback line and a preset common voltage threshold; and
perform inverse feedback on the coupling voltage according to compensation multiples of the first compensation point, the second compensation point and the third compensation point to respectively obtain a compensation voltage for the first compensation point, a compensation voltage for the second compensation point, and a compensation voltage for the third compensation point.

4. The device of claim 3, wherein the compensation multiples of the first compensation point, the second compensation point, and the third compensation point are the same or different.

5. The device of claim 1, wherein the voltage compensation lines comprise at least one first compensation line connected to the first compensation point, a second compensation line connected to the second compensation point, and a third compensation line connected to the at least one third compensation point.

6. The device of claim 5, wherein the first compensation point is at a middle position of the near-end area; and the number of the at least one third compensation points is two, and the two third compensation points are located on two sides of the far-end area, and are respectively connected to corresponding third compensation lines.

7. A display panel, comprising the common voltage compensation device for the display panel of claim 1.

8. The display panel of claim 7, comprising a display panel without a Pattern Detect Function (PDF).

9. The display panel of claim 7, comprising a vertical-screen display panel based on Chip on Glass (COG) technology, wherein a size of the display panel is greater than or equal to a preset size threshold.

10. A display device, comprising the display panel of claim 7.
